(19) United States
(12) Patent Application Publication
(10) Pub. No.: US 2021/0334293 A1
(43) Pub. Date: Oct. 28, 2021

(54) Progressive renderer of complex domain models

(71) Applicants: David McComb, Fort Collins, CO (US); Tristan vonNieda, Fort Collins, CO (US); Kaspar Polland, Fort Collins, CO (US)

(72) Inventors: David McComb, Fort Collins, CO (US); Tristan vonNieda, Fort Collins, CO (US); Kaspar Polland, Fort Collins, CO (US)

(73) Assignee: Semantic Arts, Inc., Fort Collins, CO (US)

(21) Appl. No.: 16/858,595

(22) Filed: Apr. 25, 2020

(51) Int. Cl. G06F 16/28; G06F 16/36; G06F 16/26

(52) U.S. Cl. CPC G06F 16/288; G06F 16/26; G06F 16/367

(57) ABSTRACT

An apparatus and method for rendering a complex domain model in a series of easy to understand views. The subsets of the model and the sequence of their rendering are established by the creator or other expert in the model, rather than allowing the reviewer to wander around in the model aimlessly. The tool allows reviewers to provide feedback on views, which are then tied back to the underlying model.

### DEFINITIONS OF TERMS USED

Model—as used here, the term “model” will refer to a data model, which per Wikipedia is “is an abstract model that organizes elements of data and standardizes how they relate to one another and to the properties of real-world entities.”

Domain—the subject area that is being modeled. Per dictionary.com “a field of action, thought, influence, etc.:”

Concept—a term in the domain model, either a Class or a Property.

Class—in this patent either the semantic definition, where a class is a set with formal membership criteria or the relational/object oriented definition where a class is a template for creation of instances, can be used interchangeably.

Property—in this patent a property can refer to the first class relationship as in semantics or an attribute or column, where the property is part of the class.

Ontology—our usage is the same as the US Patent Office: “A formal representation of a set of objects or concepts and the relationships between those objects or concepts, within a specific domain.”

Producer—the person who built the visualization of the model. Often the author of the model.

Consumer—someone who is attempting to understand and use the model.

Frame—a single view of the graphical presentation of the model. Synonymous in this context with “slide” in a slideshow.

Rendering—the act of turning a model object into a graphical object and displaying it.

Graphic Rendition—the styled graphic in a presentation.

Graphic Object—a selectable object in a frame.

Style Sheet—a set of rules for adjusting the way the rendering engine turns a model object into a graphic object.

Affordance—per Donald Norman “the design aspect of an object which suggest how the object should be used”

Entity Relation Model—per techopedia.com “is a theoretical and conceptual way of showing data relationships in software development.”

UML Model—per Wikipedia “is a general-purpose, developmental, modeling language in the field of software engineering that is intended to provide a standard way to visualize the design of a system.”

Progress indicator/advancer—the affordance at the bottom of a slide show to show you where (what slide number) you are and allows you to move forward and backward in the presentation.

Transition/animation—if a graphic object is retained from one slide or frame to the next, but changes position, size or appearance, the transition makes the change continuous which lets the consumer know that this is the same object, but relocated or changed in some manner.

### BACKGROUND

Designing information systems involves building models of a domain. These models inform how the data in the domain will be structured and stored. Programmers and analysts need to understand these models in order to write code and/or perform analytics. These models are often quite complex. Designers (producers) of these models often create graphic visualizations to aid the users (consumers) of the model.

Until the current invention, producers of models had two choices when it came to creating a graphic rendition of the model: either a fixed layout of the entire model, or a model that dynamically expanded as the consumer explored it. Both approaches are suboptimal as they rely on the consumer who is unfamiliar with the model to direct the exploration, which is generally haphazard and random.

Other approaches that allow a producer to direct the attention of a consumer, such as Prezi, deal only with the graphic objects and do not attempt to render a deeper domain model.

As ontologists we have been working in the field for twenty years. There are many tools for authoring ontologies, and for visualizing them, but where we spend most of our time is reviewing the model with subject matter experts. Until this invention, the only method was to present portions of the model manually in power point or by pointing with ones hands at portions of a larger model. With the current invention, it is now possible to allow reviewers to step through a complex model in a predefined sequence, where each frame is simple enough to digest and agree or disagree with, and it allows us to capture any such agreement or disagreement. Reviewers can do this at their own pace, on their own.

Not shown in the drawings, due to space limitations, the invention can also display exemplary instances from the domain and optionally show how they relate to the ontology being presented. We find for many reviewers this makes the concepts easier to understand.

### BRIEF DESCRIPTION OF THE DRAWINGS

FIG. 1 shows a small portion of a domain model in the lower half, and an even smaller subset graphically rendered in a frame in the top of the figure.

FIG. 2 shows the rendering of a second frame, showing different subset of the domain model, where one of concepts has persisted from the first frame, but has changed location.

FIG. 3 introduces the idea of a style sheet that determines the visual characteristics of the graphic objects in the frame.

FIG. 4 shows the feedback area, where reviewers of the model can agree or disagree with the model as presented and provide comments.

FIG. 5 shows the addition of graphical elements not derived from the domain model

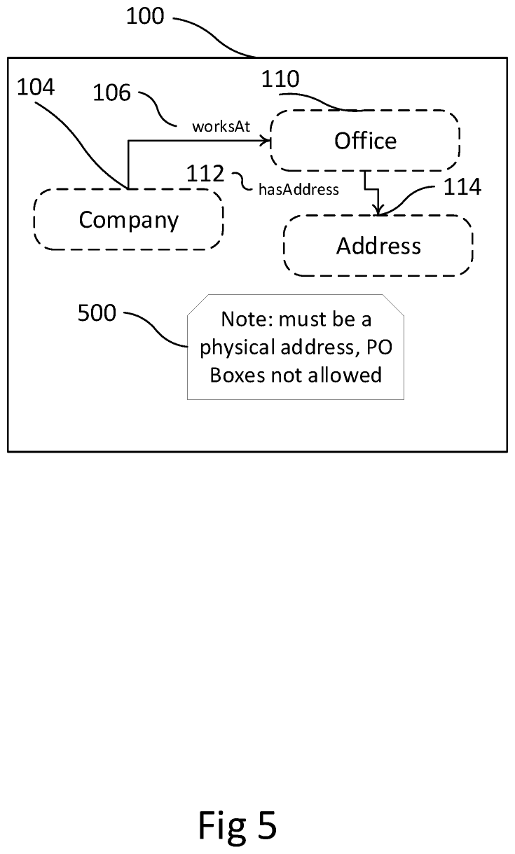

FIG. 6 shows the publisher interface, which allows the creation of new frames as well as the editing of existing frames.

### DETAILED DESCRIPTION OF THE DRAWINGS

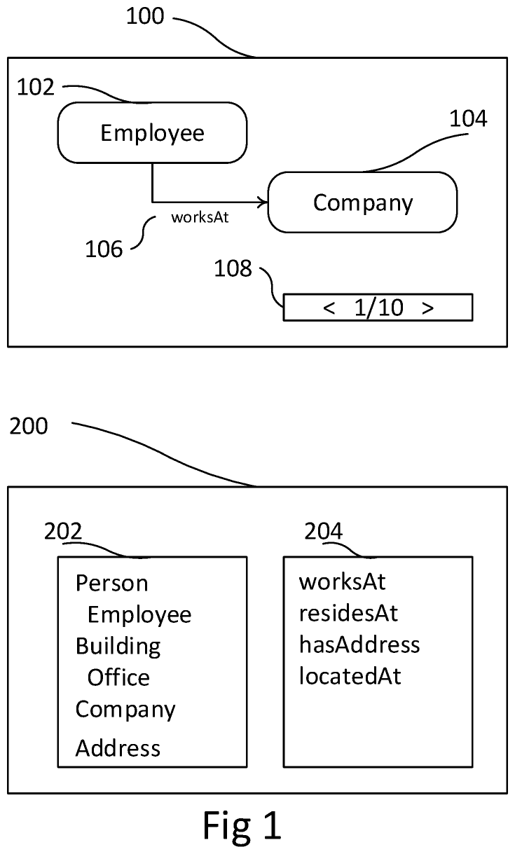

A domain model, or model of a domain, is not inherently graphic. The domain model is a description of the concepts of interest and their relationship to each other. These models typically contain hundreds to thousands of concepts and describes complex relationships between them. The illustrations here are greatly simplified. The preferred implementation is for the domain model to be a formal ontology, but the invention works with entity relation models or UML models. The bottom half of FIG. 1 shows a subset 200, of a typical domain model. The drawing separates classes 202, which are sets of instances, from properties 204, which describe how instances of classes relate to each other. The top half of FIG. 1 shows a frame 100, within which are the graphic renderings of three of the concepts from the domain model, Employee 102, Company 104 and works At 106. Also shown is the indicator/advancer 108, which allows a reviewer to move through the presentation (through the <and > buttons) and to know where they are in the presentation (1/10 is first of ten frames).

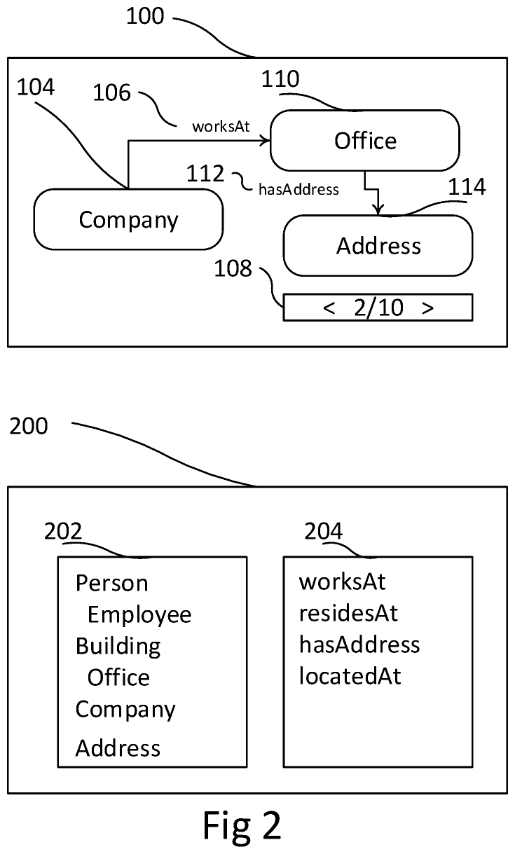

FIG. 2 shows the second frame in a presentation, as indicated in 108. The model remains unchanged, but this frame is now focused on the company 104, where it is located 110, and the address of the office, 112 and 114. The graphic rendering of the company 104, has moved from its position in frame one, and system will have provided a smooth transition from its position in frame one to its current position, which gives the reviewer a sense of continuity.

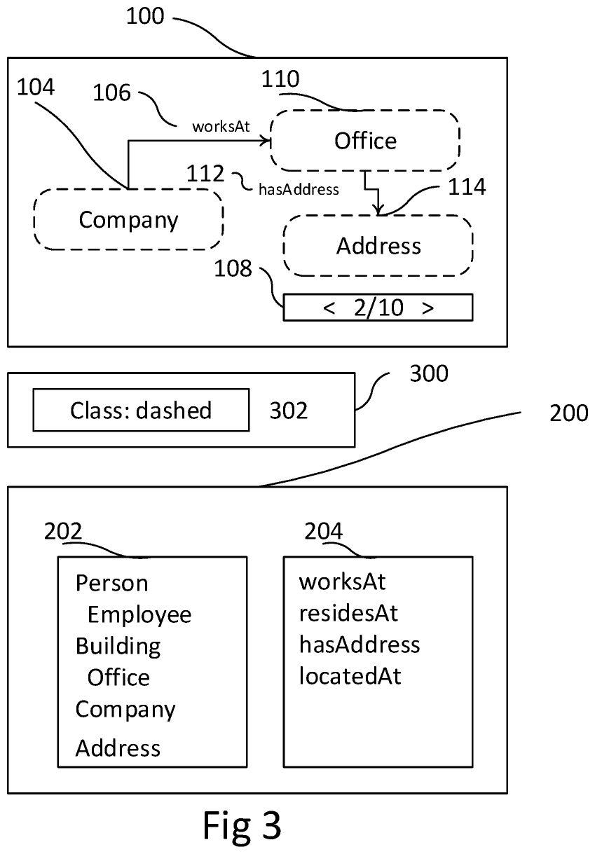

FIG. 3 introduces the concept of a style sheet 300, which allows the publisher of the presentation to build a presentation that emphasizes the points they wish to make. Graphic objects 104, 110 and 114 have accordingly been re-rendered. In this case the single style 302 tells the rendering engine to render all classes with dashed lines. A wide range of styles are possible include graphic object shapes, colors, sizes and attributes to display. Styles can apply to specific concepts (we could have a style for Company, as well as having styles for types of concepts (Classes)).

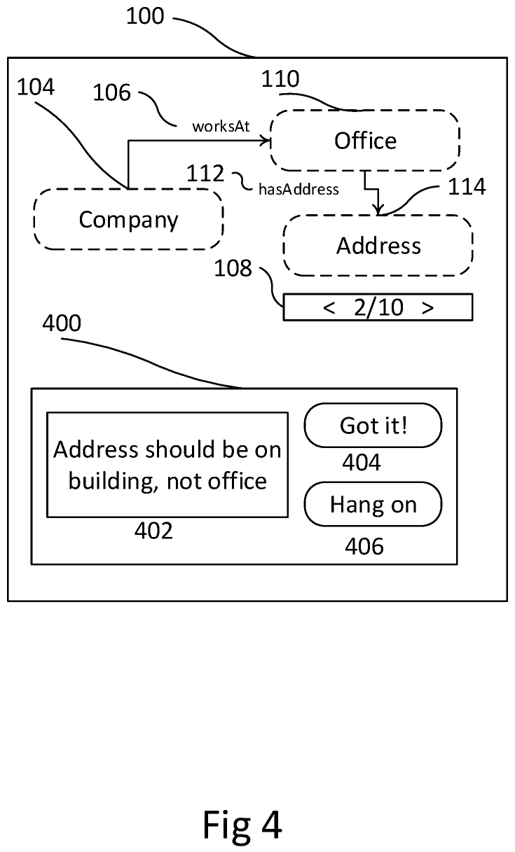

FIG. 4 shows the reviewer feedback form 400. As a reviewer considers the portion of the model being displayed, they can just click “got it” 404 to move on to the next frame. If they wish to register feedback they click “hang on” 406 and provide a comment 402. The comment may indicate that they don't understand the point being presented or it may be that they have domain expertise and are disagreeing with the characterization of the domain.

Often there is a need to supply supplemental information to a reviewer that isn't in the domain model. The annotation 500 is an example of this and is not present in the domain model but is available to help reviewers with context and explanation. It is also possible to render annotations that exist in the model.

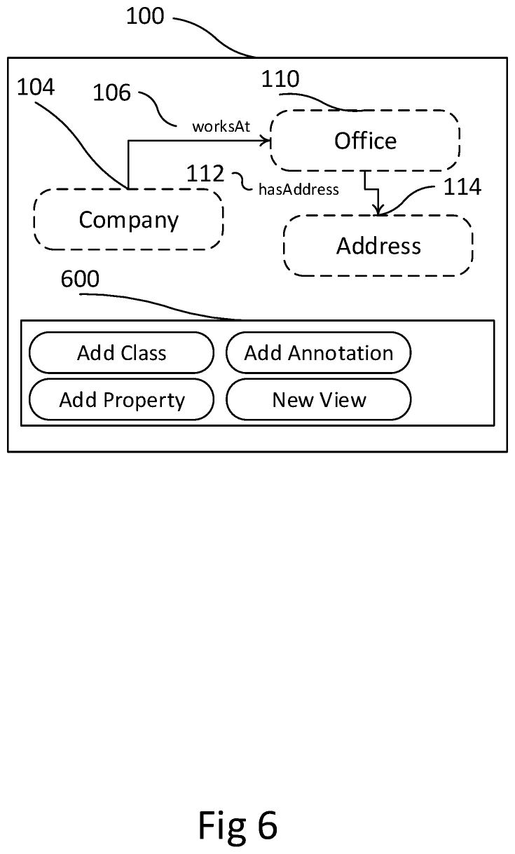

FIG. 6 shows the producers pallet 600. The producer of the presentation is typically either the author of the model or someone with deep expertise in the model. The producer has far more knowledge of the model, than the reviewer, and is in a much better position to determine which concepts should be presented first and how to layer new (to the reviewer) concepts. The producer may add new frames, rearrange the order of existing frames, add concepts to the current frame or add annotations to the frame. They can also change the position and size of graphic objects in the frame by direct manipulation.

### REFERENCES CITED

http://vowl.visualdataweb.org/webvowl.html—Webvowl is a popular tool for graphically viewing ontologies. It has no capacity to create presentations that would lead a consumer through a review process.

https://gra.fo/—grafo too is a ontology visualization tool, that also does not provide the ability to create a presentation and lead a consumer through the concepts.

https://protegewiki.stanford.edu/wiki/File:OwlViz.jpg—owlviz is one of many graphical rendering tools that renders the entirety of a model, but this leaves it to the consumer to scroll and zoom around to review portions of the model.

U.S. Pat. No. 9,703,466—Prezi is a graphic visualization tool that allows authors to create presentations from their graphical objects, but there is no underlying domain model. The graphic objects are just that, graphic objects with nothing behind them. Also once laid out, the graphic objects remain in their placed positions, there is no such thing as the object moving or changing, only the viewport.

U.S. Pat. No. 8,875,008 B2—this Microsoft patent deals with visual representation of progress through a presentation, but again does not cover the idea that the graphic is representing a deeper model.

The invention claimed is:

1. A computer implemented method comprising: storing a computer accessible model of a domain; displaying a portion of said model in a frame; in the course of displaying the graphic rendition displaying a progress indicator/advancer mechanism; and advancing the graphic rendition to a subsequent portion of the model.

2. The method of claim 1, wherein a graphical object that renders a domain object in one frame may change its position or style in the subsequent frame, the invention will provide a gradual transition/animation from the rendering in one frame to the next.

3. The method of claim 1, wherein a style sheet determines the how the domain model components will be displayed.

4. The method of claim 1, wherein the model of the domain is an ontology.

5. The method of claim 1, wherein the model of the domain is an entity relationship model.

6. The method of claim 1, wherein the model of the domain is a UML model.

7. The method of claim 1, wherein the display provides a mechanism for reviewers to provide feedback on a frame.

8. The method of claim 7, wherein the feedback is connected to the domain model concepts in the frame.

9. The method of claim 8, wherein the feedback from a plurality of reviewers can be combined in a presentation of each concept.

10. The method of claim 1, wherein the rending frame contains affordances to allow the publisher to create new frames, delete frames or reorder frames.

11. The method of claim 10, wherein the rendering frame contains affordances to allow the publisher to add, remove or reposition graphic objects in the frame.

12. The method of claim 11, wherein the rendering frame contains affordances to allow the publisher to change style sheets and thereby change the visual appearance of the rendered objects.

13. The method of claim 11, wherein the rendering frame contains affordances to allow the publisher to include graphic objects (annotations and notes), to a frame that do not exist in the model of the domain.

14. The method of claim 1, wherein changes to the domain model are automatically reflected in the rendering.

15. An apparatus comprising: at least one memory including a plurality of domain model objects; at least one processor in communication with the memory; and one or more modules comprising instructions stored in memory and executed by the processor to perform operations comprising: a computer accessible model of a domain; displaying a portion of said model in a frame; in the course of displaying the graphic rendition displaying a progress indicator/advancer mechanism; and advancing the graphic rendition to a subsequent portion of the model.

16. The apparatus of claim 15, wherein a graphical object that renders a domain object in one frame may change its position or style in the subsequent frame, the invention will provide a gradual transition/animation from the rendering in one frame to the next.

17. The apparatus of claim 15, wherein a style sheet determines the how the domain model components will be displayed.

18. The apparatus of claim 15, wherein the model of the domain is an ontology.

19. The apparatus of claim 15, wherein the model of the domain is an entity relationship model.

20. The apparatus of claim 15, wherein the model of the domain is a UML model.

21. The apparatus of claim 15, wherein the display provides a mechanism for reviewers to provide feedback on a frame.

22. The method of claim 21, wherein the feedback is connected to the domain model concepts in the frame.

23. The method of claim 22, wherein the feedback from a plurality of reviewers can be combined in a presentation of each concept.

24. The apparatus of claim 15, wherein the rending frame contains affordances to allow the publisher to create new frames, delete frames or reorder frames.

25. The apparatus of claim 24, wherein the rendering frame contains affordances to allow the publisher to add, remove or reposition graphic objects in the frame.

26. The apparatus of claim 25, wherein the rendering frame contains affordances to allow the publisher to change style sheets and thereby change the visual appearance of the rendered objects.

27. The apparatus of claim 24, wherein the rendering frame contains affordances to allow the publisher to include graphic objects (annotations and notes), to a frame that do not exist in the model of the domain.

28. The apparatus of claim 15, wherein changes to the domain model are automatically reflected in the rendering.
